(19) United States
(12) Patent Application Publication
(10) Pub. No.: US 2010/0246685 A1
(43) Pub. Date: Sep. 30, 2010

(54) Compressed video decoding delay reducer

(75) Inventor: Kim N. Matthews, Watchung, NJ (US)

Correspondence Address: MCCORMICK, PAULDING & HUBER LLP, 185 ASYLUM STREET, CITY PLACE II, HARTFORD, CT, 06103, US

(73) Assignee: Alcatel-Lucent USA Inc., Murray Hill, NJ (US)

(21) Appl. No.: 12/384,079

(22) Filed: Mar. 31, 2009

(51) Int. Cl. H04N 11/02

(52) U.S. Cl. 375/240.25; 375/E07.026

(57) ABSTRACT

In a digital video network, an encoded multimedia data stream is transmitted over the network to the end user terminal where it is decoded for viewing by a subscriber. The network includes a decoding delay reducer, which processes the encoded multimedia data stream to optimize the multimedia data stream to the operating condition of the digital video network. The optimization of the multimedia data stream enables the end user terminal to decode the encoded multimedia data stream sooner after receipt, which reduces channel change time experienced at the end user terminal due to decoding delay.

### FIELD OF THE INVENTION

The present invention relates to communications and, more particularly, to compressed video communication systems.

### BACKGROUND OF THE INVENTION

In a video communication system, such as digital cable, satellite television, Internet protocol television (IPTV), mobile video or other similar communications systems, a provider delivers digital video content to subscribers over a data communications network. Referring to FIG. 1, for example, data communications network 10 includes a number of end-user client terminals 12a-12e and one or more television content or other video/media server terminals 14. The terminals are electronic devices capable of communicating over a network, and may include, for example, home or business computer terminals 12a, 12c, network-configured television units 12b, 12d, and multimedia-capable wireless units 12e. The terminals 12a-12e, 14 are connected to a network 16 in a standard manner. For connection to the network and receiving television program files or other multimedia data, each television unit 12b, 12d may include a set top box 18a and a standard television monitor 18b. Alternatively, the television units 12b, 12d may be integrated televisions such as those known in the art. The video/media server terminal 14 supplies video channels to the end-user client terminals for viewing by the subscriber.

Each video channel is a sequence of video frames that are to be displayed on a screen of the end-user client terminal at a nominal frame rate, wherein the nominal frame rate is chosen such that the subscriber perceives successive video frames as a continuous motion sequence. The video frames are digitally captured and encoded in a post production phase 20 to compress the video data. The video frames are then transmitted to the end-user client terminals over the air (e.g. for wireless or mobile communications), by satellite or via a wired communications network. Additionally, the video channel may be transmitted with secondary media programs such as audio channels and programming information, which together comprise a multimedia data stream. The video/audio or other multimedia data may be encoded prior to transmission, for example according to a standard MPEG2 or MPEG4 format. The encoded data is then delivered as a data stream 22 to end-user terminals individually or to multiple end users simultaneously. The set top box 18a or integrated television decodes the data and converts it into standard television signals compatible with the television monitor 18b for viewing by the subscriber.

All compressed video systems suffer from the drawback that there is a large channel change time, which is the delay between a data stream being selected by the subscriber and the first images being displayed on the monitor. A subscriber selects a new data stream, for example, by changing the television channel being viewed. Channel change time has increased with the introduction of new compression schemes, in part, because decoders must buffer a sufficient number of data packets before decoding the data stream. In an attempt to address increased channel change time, some networks have implemented instant channel change (ICC) systems, which include additional networking equipment and resources directed at reducing channel change time by forwarding the new data stream immediately upon receipt of a channel change request.

However, there are several drawbacks with ICC systems. First, ICC systems are limited in that they require significant investment in hardware and network resources to provide decreased channel change time. Second, the maximum number of viewers and channels that can be supported for a given deployment of ICC hardware and network resources is limited.

Additionally, ICC systems fail to address all of the sources of channel change time because they only decrease the time from a channel request to arrival of the data of the first available non-predictive frame at the decoder. Thus, ICC systems do not address decoding delay, which is defined as the time from when the compressed frame arrives at the decoder until the decoder can begin to decompress the picture. This decoding delay is required to ensure continued correct decoding of the data stream after arrival of the first non-predictive frame (i.e. I or IDR frame) because failure to support this delay at channel change will generally result in up to several seconds of shuttering playback after the channel change is executed.

### SUMMARY OF THE INVENTION

Accordingly, an embodiment of the present invention relates to a device for reducing channel change time in a communications network. The device includes a network parameter input for inputting network parameters of the communications network. The network parameter input may be a manual input such as a keyboard, a dial or simply a connection hookup for a disconnectable input device. The device also includes a data post-processor for processing multimedia data that is to be broadcast over the communications network. The data post-processor processes the multimedia data based on the operating condition of the communications network to optimize the multimedia data stream to reduce decoding delay time of the multimedia data stream experienced at the an end user terminal.

In another embodiment of the present invention, the network parameter input is a data analyzer for analyzing the communications network to determine the operating condition of the communications network in real time.

Another embodiment of the present invention relates to an encoder for encoding a multimedia data stream in a manner that decreases channel change time by reducing decoding delay at the decoder. The encoder includes a network parameter input for inputting network parameters of a communications network. The encoder also includes a data encoding system for encoding a multimedia data stream to be broadcast over the communications network, whereby the multimedia data stream is encoded based on the network parameters to reduce decoding delay time.

Another embodiment of the present invention relates to a method for decreasing channel change time in a communications network. The method includes analyzing the communications network to determine the operating condition of the communications network. Multimedia data that is to be broadcast over the communications network is then processed based on the operating condition of the communications network to optimize the multimedia data stream to reduce decoding delay time of the multimedia data stream experienced at the an end user terminal.

### BRIEF DESCRIPTION OF THE DRAWINGS

The present invention will be better understood from reading the following description of non-limiting embodiments, with reference to the attached drawings, wherein below:

FIG. 1 is a schematic view of a communication system according to the prior art;

FIG. 2 is a schematic views of a communication system according to an embodiment of the present invention;

FIG. 3 is a schematic view of a multimedia data stream prior to being processed transmission through the communication system of FIG. 2;

FIG. 4A is a schematic view of the multimedia data stream during processing in the communication system of FIG. 2;

FIG. 4B is a schematic view of the processed multimedia data stream of FIG. 3;

FIG. 5 is a flowchart showing the communication system of FIG. 2 in operation;

FIG. 6 is a schematic view of an alternate embodiment of the communication system of FIG. 2;

FIG. 7 is a schematic view of a communication system according to another embodiment of the present invention;

FIG. 8 is a flowchart showing the communication system of FIG. 7 in operation;

FIG. 9 is a schematic view of a communication system according to another embodiment of the present invention; and

FIG. 10 is a flowchart showing the communication system of FIG. 9 in operation.

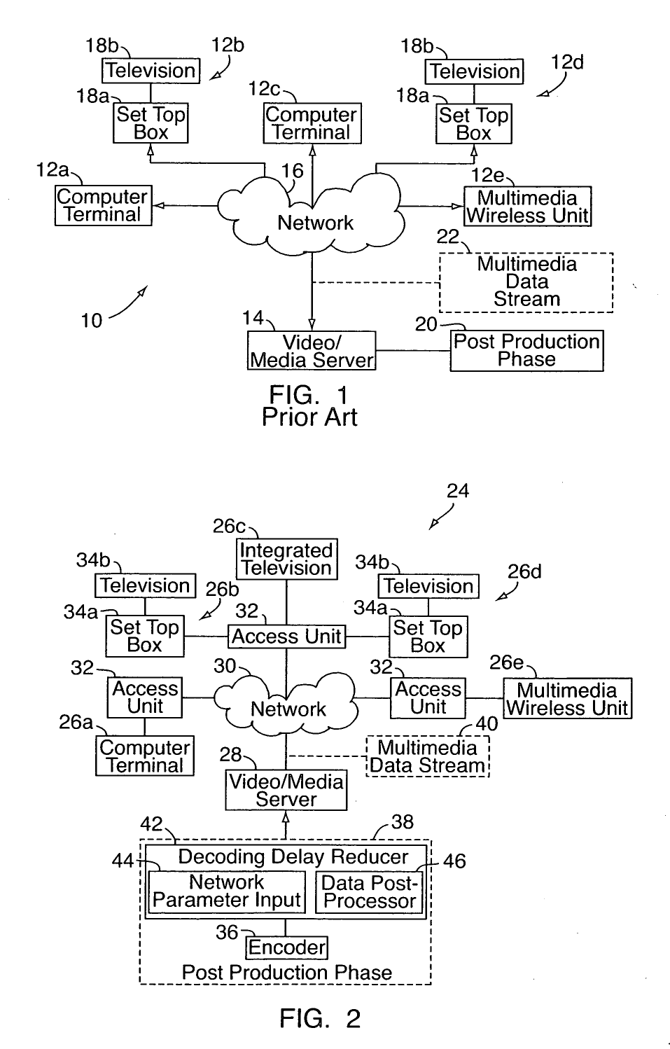

### DETAILED DESCRIPTION

With reference to FIG. 2, data communications network 24 includes a number of end-user client terminals 26a-26e and one or more television content or other video/media server terminals 28. The terminals are electronic devices capable of communicating over a network 30, and may include, for example, home or business computer terminals 26a, network-configured television units 26b, 26d, integrated televisions 26c and multimedia-capable wireless units 26e. The terminals 26a-26e, 28 are connected to the network 30 in a standard manner. For example, the network 30 may include one or more access units 32, through which the end-user client terminals 26a-26e may be connected to network 30. The access units 32 are, for example, routers, digital subscriber line access multiplexers (DSLAM) or any other similar communication access units. For connection to the network 30 and receiving television program files or other multimedia data, each television unit 26b, 26d may include a set top box 34a and a standard television monitor 34b. Alternatively, the television units may be integrated televisions 26c, such as those known in the art. The video/media server terminal 28 supplies video channels to the end-user client terminals 26a-26e for viewing by the subscriber.

Each video channel is a sequence of video frames that are to be displayed on a screen of the end-user client terminal 26a-26e at a nominal frame rate, wherein the nominal frame rate is chosen such that the subscriber perceives successive video frames as a continuous motion sequence. The video frames are digitally captured and encoded by an encoder 36 to compress the video data. Encoding of the video data at encoder 36 is typically done during a post-production phase 38 of multimedia processing. After the post-production phase 38, the compressed video data is transmitted to the end-user client terminals 26a-26e over the air (e.g. for wireless or mobile communications), by satellite or via a wired communications network by the video/media server 28. Additionally, the video channel may be transmitted with secondary media programs such as audio channels and programming information, which together comprise a multimedia data stream 40. For example, in the case of a television program episode, the programming information could include the name of the television show, identifying information of the particular episode, a plot summary, a cast listing, reviews and play length. The video/audio or other multimedia data, constituting the multimedia data stream 40, is encoded by the encoder 36 prior to transmission according to a standard MPEG2 or MPEG4 format.

Communications networks have various network parameters that define how data flows through the network. For example, network 30 has a bandwidth that defines the network's capacity to transfer data, i.e. the potential speed at which data can be sent through the network. In communications networks, a high bitrate portion of the bandwidth is typically allocated to video transmissions and a lower bitrate portion is typically allocated to internet transmissions. For example, in a Digital Substriber Line (DSL) network having a bandwidth of 3.5 Megabits per second, 3 Megabits per second may be allocated to video transmissions and 0.5 Megabits per second to internet transmissions. The network 30 may also be defined by a jitter parameter directed to network jitter, i.e. the delay due to queuing of packets within the network 30, and a burst parameter that is directed to the size of the data bursts transmitted within the network. These network parameters define the actual speed or average bitrate that each video frame is transmitted through the network. Thus, a larger video frame, i.e. a video frame with more encoded data, will require more time to be transmitted through the network and the variation between the time required to transmit each video frame is defined as the jitter of the multimedia data stream 40.

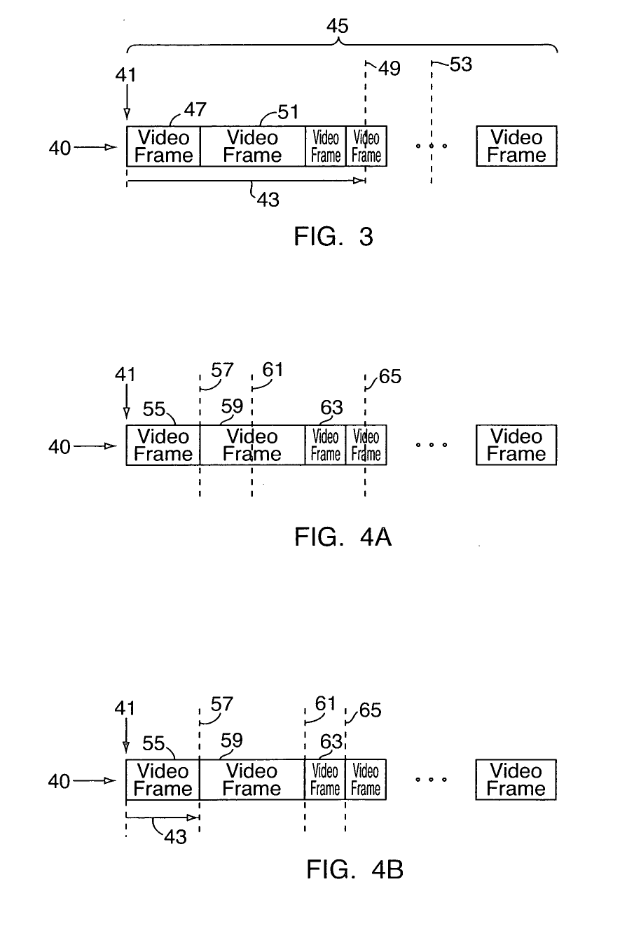

Referring to FIG. 3, when the subscriber requests a channel change 41 in the multimedia data stream 40 being transmitted, i.e. the subscriber changes television stations, decoding delay 43 is experienced due to the request. Decoding delay 43 develops because the decoder must buffer a specified length of the multimedia data stream 40 prior to decoding to ensure that all of the encoded data for each video frame 45 is fully received at the decoder prior to initiating decoding of that video frame 45. For example, video frame 47 must fully arrive at the decoder prior to decoding time 49 and video frame 51 must fully arrive at the decoder prior to decoding time 53. Without buffering the multimedia data stream 40, a larger video frame 51 may not arrive at the decoder prior to the decoding time 53, which will result in shuttered playback of the video. Thus, buffering the multimedia data stream 40 introduces decoding delay to ensure that the differences between the structure of the encoded video frames 45 within the multimedia data stream 40 and the network system parameters that define how the encoded video frames 45 are transmitted through the network 30 are compensated for, such that each frame has arrived at the decoder prior to being decoded. Decoding delay is defined at the time that the multimedia data stream 40 is encoded because each video frame 45 is encoded by the encoder 36, without accounting for the operating conditions of the network, which ultimately affect the time required for each video frame 45 of the multimedia data stream 40 to arrive at the end-user client terminals 26a-26e and, therefore, how the multimedia data stream 40 is decoded when received by the set top box 34a or integrated television 26c.

Referring back to FIG. 2, the present invention implements a decoding delay reducer 42 as the final step of the post-production phase 38 to process the compressed multimedia data stream 40 to be more compatible with the network 30, thereby reducing the decoding delay due to channel change. The decoding delay reducer 42 reduces the need to buffer the multimedia data stream 40 at the decoder, thereby allowing decoding to begin sooner after the arrival of the first video frame 45 at the set top box 34a or integrated television 26c.

The decoding delay reducer 42 includes a network parameter input 44, which allows network parameters to be input into the decoding delay reducer 42, thereby providing information about the operating condition of the network 30 to the decoding delay reducer 42. For example, the network parameter input 44 may be a keyboard, an analog/digital dial, a connection hookup for a disconnectable input device or any other similar data input device. The decoding delay reducer 42 also includes a data post-processor 46, which uses the network parameters input with the network parameter input 44 to post-process the encoded multimedia data steam 40 by adjusting the data packets of the multimedia data stream 40 to transmit more efficiently through the network 30.

The decoding delay reducer 42 receives the multimedia data stream 40, which provides information on the size of each video frame 45 and the time that each video frame 45 is to be decoded. Using this information, along with the information on the operating condition of the network provided by the network parameter input 44, the data post-processor 46 analyzes the multimedia data stream to identify whether, under the network operating conditions, the video frames 45 will arrive early, on time or late relative to the times that the video frames 45 must be decoded. For example, referring to FIG. 4A, it can be seen that after a channel change request 41, without buffering the multimedia data stream 40, video frame 55 will arrive the decoding time 57 that it is to be decoded. However, video frame 59 will arrive late, i.e. after decoding time 61, and video frame 63 will arrive early, i.e. before decoding time 65. The data post-processor 46 then adjusts the jitter and/or burst characteristics of the video frames 45 of the multimedia data steam 40 using the network operating information provided by the network parameters. For instance, in the DSL network example above, having a bandwidth of 3.5 Megabits per second with 3 Megabits per second allocated to video transmissions, the decoding delay reducer 42 may process video frame 59, which would arrive late under normal operating conditions, to be transmitted at an increased bitrate by temporarily using all or a portion of the 0.5 Megabit bandwidth allocated to internet transmissions. Similarly, video frame 59 may be processed to transmit at a decreased bitrate, since it will arrive early under normal operating conditions. Thus, the decoding delay reducer 42 affects the time between the arrival of each video frame 54 at the decoder and the time at which it must be decoded by increasing and decreasing the instantaneous transmission rate of the multimedia stream 40.

Referring to FIG. 4B, the decoding delay reducer 42 processes the multimedia data stream 40 under the constraints that all of the encoded data for a video frame, i.e. video frame 59, must arrive before being decoded and that all of the encoded data of a preceding video frame, i.e. video frame 55, must arrive completely before decoding of the next video frame, i.e. video frame 59, begins. Thus, the bitrate at which video frame 59 is transmitted through the network is increased so that video frame 59 arrives more quickly at the decoder, and the bitrate at which video frame 63 is transmitted through the network is decreased. By adjusting all of the video frames in this manner, the decoding delay reducer 42 ensures that each video frame will fully arrive at the decoder prior to the time at which it is to be decoded. Thus, the adjustments made by the decoding delay reducer 42 reduce the delay experienced during decoding of the multimedia data stream 40 at the set top box 34a or integrated television 26c by increasing the jitter of the multimedia data stream 40 and enabling decoding to begin sooner upon receipt of the first data packets of the multimedia data stream 40. Additionally, adjusting video frames 45 that would normally arrive early to be transmitted at a decreased bitrate ensure compliance with MPEG standards because the average bitrate of the multimedia data stream 40 remains the same.

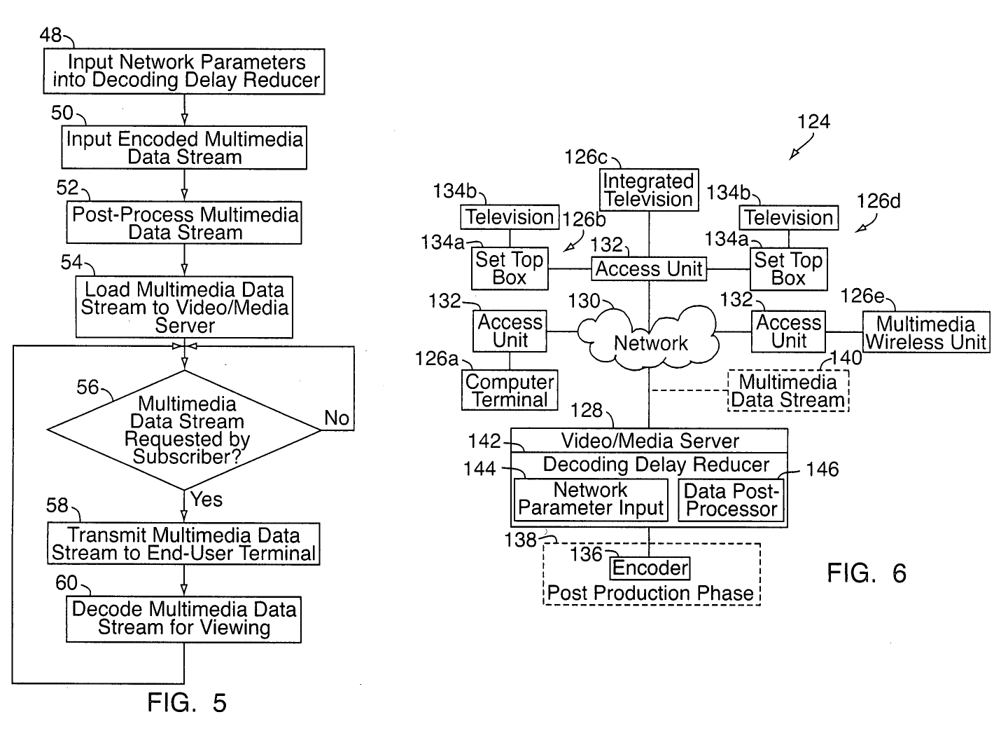

Referring to FIG. 5, the network parameters defining network 30 are input into the decoding delay reducer 42 through network parameter input 44 in step 48. Step 48 may be executed prior to the processing of each multimedia data stream 40 by the decoding delay reducer 42 to account for changes in the condition of network 30. Alternatively, step 48 may be executed only as an initial step to configure the decoding delay reducer 42 for the network 30, such that the network parameters input in step 48 are used to process multiple multimedia data streams 40. In which case, step 48 may be eliminated for processing subsequent multimedia data streams 40 for the same network 30. In step 50, the encoded multimedia data stream 40 that is to be processed is input into the decoding delay reducer 42. In step 52, the data post-processor 46 of the decoding delay reducer 42 uses the network parameters input through the network parameter input 44 to process the multimedia data stream 40 as discussed above. The data post-processor adapts and smoothes the multimedia data stream 40 for more efficient transmission through the network 30, such that decoding delay experienced at the set top box 34a or integrated television 26b is reduced.

The decoding delay reducer 42 may be implemented to process only the video data channel of the multimedia data stream 40, the secondary media programs or a combination of the video and secondary channels. By processing a combination of the video and secondary channels, the decoding delay reducer 42 is able to retime the secondary media programs to create extra bandwidth for the video channel where required, such that the jitter between the video and audio channels is traded, resulting in a processed multimedia data stream 40 that has reduced jitter.

After being processed by data post-processor 46 of the decoding delay reducer 42, the multimedia data stream 40 is loaded to the video/media server 28 in step 54 so that it can be transmitted over the network 30 to the subscriber. Thus, when the subscriber executes a channel change request in step 56, i.e. the subscriber requests the processed multimedia data stream 40, the multimedia data stream 40 is transmitted through the network in step 58 to the end-user client terminal 26a-26e and minimal jitter is experienced because of the processing at the decoding delay reducer 42. The multimedia data stream 40 may be delivered to end-user terminals 26a-26e individually or to multiple end user terminals simultaneously. In step 60, the set top box 34a or integrated television 26b decodes the encoded multimedia data stream 40 and converts it into standard television signals compatible with the television monitor for viewing by the subscriber. The processing of the multimedia data stream at the data post-processor 46 provides for reduction or elimination of the decoding delay experienced at the set top box 34a or integrated television 26c. Thus, channel change time is reduced, resulting in cleaner channel changes without shuttering playback. Additionally, by improving channel change time through the reduction in decoding delay, the present invention reduces the demand on instant channel change (ICC) systems.

Implementing the decoding delay reducer 42, as discussed above, as the final stage of the post production phase 38 is beneficial because it allows for the processing of the encoded multimedia data stream 40 to be done while the data is offline, i.e. not yet being transmitted through the network 30, which means that the entire multimedia data stream 40 may be processed at once. However, providing the decoding delay reducer 42 as the final stage of the post production phase 38 may not always be practical because the multimedia data stream 40 may be transmitted over multiple networks 30, each network operating under different conditions and, therefore, being defined by different network parameters. Thus, the network parameters input into the decoding delay reducer 42 may result in processing that improves decoding delay for one network 30 while having the opposite effect on another network 30. Thus, processing the multimedia data stream 40 as the final stage of the post production phase 38 makes it difficult to process the data to be optimally transmitted over multiple networks 30.

Referring to FIG. 6, wherein like numerals represent like elements, another embodiment of the invention includes communications network 124 having the decoding delay reducer 142 provided integrally with the video/media server 128. This embodiment still provides for offline processing of the multimedia data stream 140, whereby the multimedia data stream 140 is processed by the decoding delay reducer 142 as a step during loading of the video/media server 128. The decoding delay reducer 142 is operationally identical to the decoding delay reducer 42 shown in FIG. 2 in that decoding delay reducer 142 also includes network parameter input 144, which allows network parameters to be input into the decoding delay reducer 142 for providing information about the operating condition of the network 130 to the decoding delay reducer 142. The decoding delay reducer 142 also includes a data post-processor 146, which uses the network parameters input with the network parameter input 144 to post-process the encoded multimedia data steam 140 by adjusting the data packets of the multimedia data stream 140 to transmit more efficiently through the network 130. The adjustments made by the decoding delay reducer 142 minimize or reduce the delay experienced during decoding of the multimedia data stream 140 at the set top box 134a or integrated television 126c by enabling decoding to begin immediately upon receipt of the first data packets of the multimedia data stream 140. However, by moving the decoding delay reducer 142 out of the post production phase 138 and instead integrating it with the video/media server 128, the encoded multimedia data stream 140 can be transmitted over multiple networks 130, with each network 130 having a decoding delay reducer 142 configured with network parameters specifically designed to process the compressed multimedia data stream 140 for that network 130.

As discussed above, the embodiment of FIG. 6 operates according to the process shown in FIG. 5. However, in the embodiment of FIG. 6, steps 48-52 are executed as part of the process of loading the multimedia data stream 140 onto the video/media server 128, rather than being executed during the post production phase 138. Although shown integrally with video/media server 128 in FIG. 6, the decoding delay reducer 142 may be implemented as a hardware module, hardware/software module, or software module (e.g., script or other software program, or suite of software programs), in a standalone manner, communicating with the video/media server 128.

Implementing the decoding delay reducers 42, 142 to provide processing of the multimedia data stream 40, 140 as the final stage of the post production phase 38 or as a step during loading of the video/media server 128 is beneficial because both embodiments allow for the processing of the encoded multimedia data stream 40, 140 to be done while the data is offline, i.e. not yet being transmitted through the network 30, 130. However, this offline processing may not always be practical, as the network parameters of the network 30, 130 may not be known in advance.

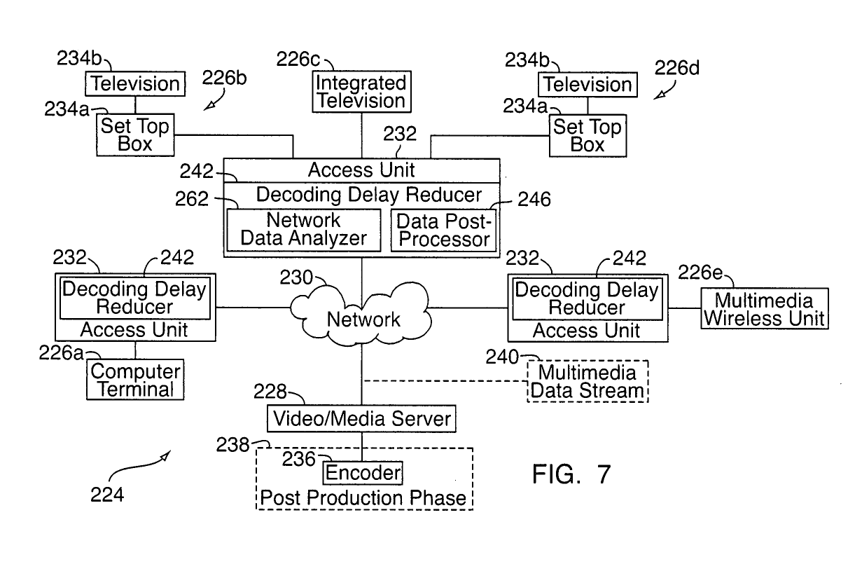

Referring to FIG. 7, in another embodiment of the present invention, the decoding delay reducer 242 is integrated directly into the network 230. For example, in the exemplary embodiment, the decoding delay reducer 242 is integrated into the network 230 through the access unit 232, which may be a router, DSLAM, or any other similar communications network access unit. Integrating the decoding delay reducer 242 of the present invention into the network 230 provides for additional optimization of the adjustments made to the multimedia data stream 240 by the decoding delay reducer 242 during processing.

In decoding delay reducer 242, the network parameter input of the decoding delay reducer 242 is a network data analyzer 262, which communicates with the network 230 to detect and input the network parameters as they are defined in real-time. The decoding delay reducer 242 also includes a data post-processor 246, which uses the network parameters input through the network data analyzer 262 to post-process the encoded multimedia data steam 240 by adjusting the data packets of the multimedia data stream 240 to transmit more efficiently through the network 230. However, rather than processing the entire multimedia data stream 240, the decoding delay reducer 242, which processes the multimedia data stream 240 for optimal decoding as it is being transmitted through the network, will buffer a portion of the data that is being transmitted and process the buffered data in the same manner discussed above. The network data analyzer 262 enables the decoding delay reducer 242 to adapt to changes in the operating condition of the network 230 during processing of the multimedia data stream 240. Thus, integrating the decoding delay reducer 242 into the network 230 further optimizes the processing capability of the decoding delay reducer 242 because the decoding delay reducer 242 is able compensate for any changes or variations in the operating condition of the network 230 as they occur. Accordingly, the real-time data processing of the decoding delay reducer 242 compensates for real-time changes to the operating condition of the network and, therefore, provides for near optimal minimization of the decoding delay.

Although shown integrally with access unit 232 in FIG. 7, the decoding delay reducer 242 may be integrated into the network 230 as a hardware module, hardware/software module, or software module (e.g., script or other software program, or suite of software programs), in a standalone manner, communicating with the network 230. Transmission of the multimedia data stream 240 over network 230 having the standalone decoding delay reducer is carried out in the same manner as that of an integrated decoding delay reducer 242.

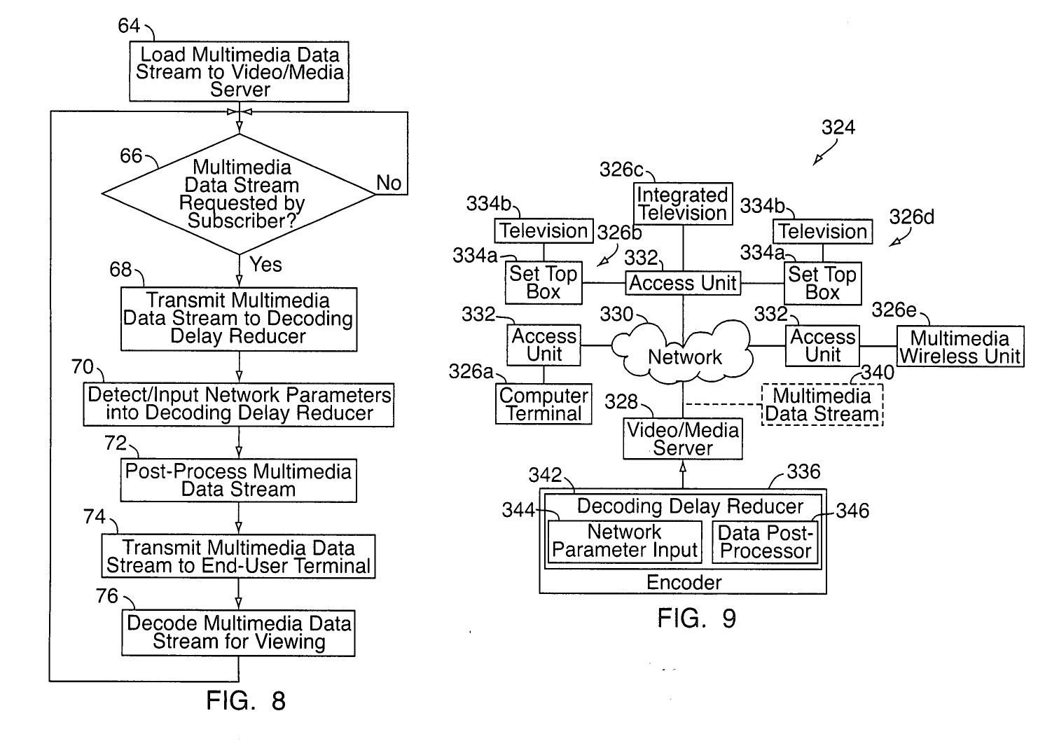

Referring to FIG. 8, in operation, the encoded multimedia data stream 240 is loaded on the video/media server 228 in step 64, in any suitable manner known in the art. In step 66, the subscriber executes a channel change request, i.e. the subscriber requests the encoded multimedia data stream 240. The encoded multimedia data stream 240 is then transmitted through the network 230 to the decoding delay reducer 242 in step 68. For example, as seen in FIG. 7, the multimedia data stream 240 would be transmitted to access unit 232, with which the decoding delay reducer 242 is integrated. Referring back to FIG. 8, in step 70, the network data analyzer 262 of the decoding delay reducer 242 detects and inputs the real-time network parameters and information on data steam buffering within the communications network 230. In step 72, the data post-processor 246 of the decoding delay reducer 242 uses the real-time network parameters and information to process the multimedia data stream 240. The multimedia data stream is adapted by the data post-processor 246 to optimize decoding so that the decoding delay experienced at the set top box 234a or integrated television 226b is reduced. The post-processed encoded multimedia data stream 240 is then delivered from the decoding delay reducer 242 to end-user client terminals 226a-226e individually or to multiple end user client terminals simultaneously over network 230 in step 74. In step 76, the set top box 234a or integrated television 226b decodes the multimedia data stream 240 and converts it into standard television signals compatible with the television monitor 234b for viewing by the subscriber. Upon a subsequent channel change request by the subscriber, steps 66-76 are repeated to transmit the new multimedia data steam 240 for the new channel. This improved transmission provides for reduction of the decoding delay experienced at the set top box 234a or integrated television 226b, thereby reducing channel change time, resulting in improved channel changes, i.e. without shuttering playback, and reducing demand on instant channel change (ICC) systems.

Referring to FIG. 9, in another embodiment of the present invention, the decoding delay reducer 342 is integrated into the encoders 336 used to transmit live broadcast media. The decoding delay reducer 342 may be integrated into the encoder 336 as a hardware module, hardware/software module, or software module (e.g., script or other software program, or suite of software programs). The decoding delay reducer 342 includes a network parameter input 344, which allows network parameters to be input into the decoding delay reducer 342. The decoding delay reducer 342 also includes a data post-processor 346, which uses the network parameters providing information about the network 330 to post-process the multimedia data steam 340 during the encoding process by adjusting the data packets of the multimedia data stream to transmit more efficiently through the network 330. Similar to the real-time decoding delay reducer 242 discussed above, the decoding delay reducer 342 for line broadcast media will buffer a portion of the data that is being transmitted and process the buffered data in the same manner discussed above. The adjustments made by the decoding delay reducer 342 reduce the delay experienced during decoding of the multimedia data stream 340 at the set top box 334a or integrated television 326c by enabling decoding to sooner upon receipt of the first data packets of the multimedia data stream 340. Integrating the decoding delay reducer 342 into the encoder 336 enables the optimization to the multimedia data stream 340 to be carried out as a step during the encoding process. Thus, the output of the encoder 336 is optimized for the network 330.

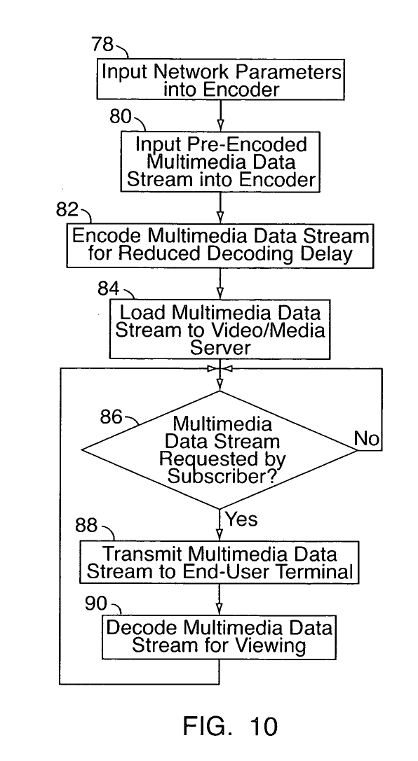

Referring to FIG. 10, in step 78, the encoder 336 having the integral decoding delay reducer 342 is programmed with the network parameters in a manner similar to that previously described. The encoder then inputs the un-encoded multimedia data stream 340 in step 80. In step 82, the encoder 336 having the integral decoding delay reducer 342 uses the network parameters to optimize the multimedia data stream 340 during the encoding process. The encoded multimedia data steam 340 is then loaded on the video/media server 328 in step 84, so that it may be transmitted to the subscriber upon request. In step 86, the subscriber executes a channel change request, i.e. the subscriber requests the encoded multimedia data stream 340. The encoded multimedia data stream 340 is transmitted through the network 330 in step 88. The encoded multimedia data stream 340 may be delivered to end-user terminals 326a-326e individually or to multiple end user terminals simultaneously. In step 90, the set top box 334a or integrated television 326c decodes the multimedia data stream 340 and converts it into standard television signals compatible with the television monitor 334b for viewing by the subscriber. This embodiment eliminates the need for a separate network entity for post-processing the multimedia data stream 340, while at the same time minimizing the channel change time experienced by the subscriber.

The above-described embodiments of the present invention reduce channel change time experienced by subscribers at the end-user client terminals for all digital video systems. Thus, the present invention provides faster channel changes without generating shuttered playback. Additionally, the present invention reduces the demand on system resources, such as additional servers and bandwidth, in networks that implement ICC systems.

Since certain changes may be made in the above-described decoding delay reducer for video communications networks, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A device for decreasing channel change time, the device comprising:
a network parameter input for inputting network parameters of a communications network; and
a data post-processor for processing a multimedia data stream to be broadcast over the communications network;
wherein the data post-processor processes the multimedia data stream based on the network parameters to reduce decoding delay time of the multimedia data stream.

2. The device according to claim 1, wherein the network parameter input includes an input for a bandwidth parameter, a jitter parameter and a burst parameter.

3. The device according to claim 2, wherein the data post-processor adapts the multimedia data stream to be more compatible with the network parameters to reduce decoding delay time.

4. The device according to claim 3, wherein the data post-processor adjusts the multimedia data stream jitter and burst characteristics.

5. The device according to claim 1, wherein the network parameter input includes a data analyzer for analyzing the communications network to determine network parameters of the communications network in real time.

6. The device according to claim 5, wherein the data analyzer determines network parameters including a bandwidth parameter, a jitter parameter and a burst parameter.

7. A live broadcast multimedia encoder comprising:
a network parameter input for inputting network parameters of a communications network; and
a data encoding system for encoding a multimedia data stream to be broadcast over the communications network;
wherein the data encoding system encodes and processes the multimedia data stream based on the network parameters to reduce decoding delay time of the multimedia data stream at an end user terminal.

8. The encoder according to claim 7, wherein the network parameter input includes an input for a bandwidth parameter, a jitter parameter and a burst parameter.

9. The encoder according to claim 8, wherein the data encoding system adapts the multimedia data stream to be more compatible with the network parameters to reduce decoding delay time.

10. The encoder according to claim 9, wherein the data encoding system adjusts the multimedia data stream jitter and burst characteristics.

11. The encoder according to claim 7, wherein the network parameter input includes a data analyzer for analyzing the communications network to determine network parameters of the communications network in real time.

12. The encoder according to claim 11, wherein the data analyzer determines network parameters including a bandwidth parameter, a jitter parameter and a burst parameter.

13. A method for decreasing channel change time, said method comprising:
receiving network parameters of a communications network; and
post-processing a multimedia data stream based on the network parameters to reduce decoding delay time.

14. The method of claim 13, wherein analyzing the communications network to determine network parameters includes analyzing a network bandwidth.

15. The method of claim 13, wherein post-processing the multimedia data stream includes adjusting one or more secondary media programs.

16. The method of claim 15, wherein the secondary media programs include audio channels.

17. The method of claim 15, wherein the secondary media programs include program information.

18. The method of claim 13, wherein post-processing the multimedia data stream based on the network parameters to reduce decoding delay time includes retiming of secondary media programs.

19. The method of claim 13, wherein analyzing the communications network to determine network parameters includes analyzing a network jitter characteristic.

20. The method of claim 13, wherein analyzing the communications network to determine network parameters includes analyzing a network burst characteristic.
